(19) United States
(12) Patent Application Publication
(10) Pub. No.: US 2007/0080637 A1
(43) Pub. Date: Apr. 12, 2007

(54) IMAGE DISPLAY APPARATUS AND METHOD OF MANUFACTURING THE IMAGE DISPLAY APPARATUS

(76) Inventors: Yuusuke KASAHARA, Fukaya-shi (JP); Hiromasa Mitani, Hiratsuka-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/611,175

(22) Filed: Dec. 15, 2006

Related U.S. Application Data
(63) Continuation of application No. PCT/JP05/11073, filed on Jun. 16, 2005.

(30) Foreign Application Priority Data
Jun. 18, 2004 (JP) 2004-180976
Jun. 22, 2004 (JP) 2004-183754

(51) Int. Cl. H01J 17/24; H01J 61/26; H01J 19/70

(52) U.S. Cl. 313/553

(57) ABSTRACT

An image display apparatus includes an envelope including a front substrate on which a display surface is provided, and a rear substrate arranged to face the front substrate. The front substrate includes a metal back formed to be overlaid on the display surface and a getter film formed of two types or more of activated metals, formed on the metal back.

### CROSS REFERENCE TO RELATED APPLICATIONS

This is a Continuation Application of PCT Application No. PCT/JP2005/011073, filed Jun. 16, 2005, which was published under PCT Article 21(2) in Japanese.

This application is based upon and claims the benefit of priority from prior Japanese Patent Applications No. 2004-180976, filed Jun. 18, 2004; and No. 2004-183754, filed Jun. 22, 2004, the entire contents of both of which are incorporated herein by reference.

### BACKGROUND OF THE INVENTION

1. Field of the Invention

The present invention relates to an image display apparatus comprising a front substrate and a rear substrate, which are set to oppose each other, and a method of manufacturing an image display apparatus.

2. Description of the Related Art

Recent years, there have been various flat-panel image display apparatus proposed and receiving attention as light-weight and thin display apparatus of the next generation in place of the cathode ray tube (to be referred to as CRT hereinafter). For example, the plasma display panel (PDP) that utilizes the light emission of the phosphor by discharge phenomenon, the field emission display (to be called FED hereinafter) that mainly utilizes the electron emission by electrical field, and the surface conduction electron emission device (to be called SED hereinafter) are typical conventionally known apparatus.

These image display apparatus each comprise a front substrate and a rear substrate that are opposed to each other across a predetermined gap. These substrates have their respective peripheral portions joined together, thereby forming an envelope. In the case of the FED in particular, it is possible to achieve excellent image display by maintaining the space between the front substrate and rear substrate, that is, the internal portion of the envelope, at a high vacuum degree. On the other hand, in the case of the PDP, it is important to maintain the inert gas filling the internal portion of the envelope at a high purity.

In order to maintain the internal portion of the envelope at a high vacuum degree over a long period of time, a getter material for adsorbing the released gas is provided in the envelope, and it serves an important role. For example, Jpn. Pat. Appln. KOKAI Publication No. 2001-229824 proposes an image display apparatus, a method of manufacturing such an apparatus, and a device for manufacturing such an apparatus, in which a getter material is deposited on an inner surface of the front substrate, rear substrate, or other structures in vacuum processing apparatus, and these substrates are bonded together in the vacuum, thereby forming the envelope. It is general in the apparatus to use barium or titanium as the getter material. It is further general to use one type of activated metal as the getter material.

Conventionally, in a getter forming step, a single getter material is employed since the formation of a getter film is easy by that way. However, with a single getter material, it is not always possible to achieve a sufficient gas adsorption speed or gas adsorption amount. For example, with barium, which is a general getter material, hydrogen cannot be sufficiently adsorbed. On the other hand, with titanium, which is generally employed as a getter pump, carbohydrate gas cannot be sufficiently adsorbed although hydrogen can be sufficiently adsorbed. Thus, even with use of these getter materials, the vacuum degree and gas purity in the envelope which constitutes the image display apparatus, deteriorate in a short period of time, and therefore it becomes difficult to keep a high vacuum degree in the image display apparatus and maintain a high image display performance over a long period of time.

### BRIEF SUMMARY OF THE INVENTION

The present invention has been achieved in the light of the above-described point and its object is to provide an image display apparatus that can maintain a high display performance over a long period of time by improving the gas adsorption ability of the getter film.

According to an aspect of the present invention, there is provided an image display apparatus comprising: an envelope including a front substrate on which a display surface is provided, and a rear substrate arranged to face the front substrate, the front substrate including a metal back formed to be overlaid on the display surface and a getter film made of two types or more of activated metals, formed on the metal back.

According to another aspect of the present invention, there is provided a method of manufacturing an image display apparatus comprising: an envelope including a front substrate on which a display surface is provided, and a rear substrate arranged to face the front substrate, the front substrate including a metal back formed to be overlaid on the display surface and a getter film made of two types or more of activated metals, formed on the metal back, the method comprising:

placing the front substrate on which the metal back is formed, in a vacuum chamber; after evacuating the vacuum chamber to vacuum, evaporating a first getter material made of an activated metal in the vacuum chamber to form a first getter film in the vacuum chamber; forming a second getter film on the metal back by evaporating a second getter material made of tantalum in the vacuum chamber after forming the first getter film; and sealing the front substrate on which the second getter film is formed and the rear substrate to each other by peripheral edge portions thereof to form the envelope.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view showing an SED according to a first embodiment of the present invention;

FIG. 2 is a sectional view showing the SED taken along the line II-II in FIG. 1;

FIG. 3 is a sectional view schematically showing the structure of a getter film of the SED;

FIG. 4 is a diagram showing comparison between types of getter materials in the display performance maintaining rate of the SED;

FIG. 5 is a diagram showing comparison in terms of gas adsorption amount between the cases where the getter film of the SED is formed of barium, titanium and a co-use of barium-titanium;

FIG. 6 is a diagram showing comparison in terms of gas adsorption amount between the cases where the getter film of the SED is formed of tantalum, titanium and a co-use of tantalum-titanium;

FIG. 7 is a sectional view showing a device of forming the getter film in the SED;

FIG. 8 is a sectional view showing a sealing device used in the manufacture of the SED;

FIG. 9 is a sectional view showing a front substrate of an SED according to a second embodiment of the present invention;

FIG. 10 is a sectional view showing a front substrate of an SED according to a third embodiment of the present invention;

FIG. 11 is a sectional view showing a device of forming a getter film according to the third embodiment of the present invention;

FIG. 12 is a plan view showing a mask used in the formation of the getter film according to the second embodiment of the present invention;

FIG. 13 is a sectional view showing a device of forming a getter film according to a fourth embodiment of the present invention; and

FIG. 14 is a diagram schematically showing steps of forming the getter film.

### DETAILED DESCRIPTION OF THE INVENTION

Embodiments in which the present invention is applied to an SED as a flat-panel image display apparatus, will now be described in detail with reference to accompanying drawings.

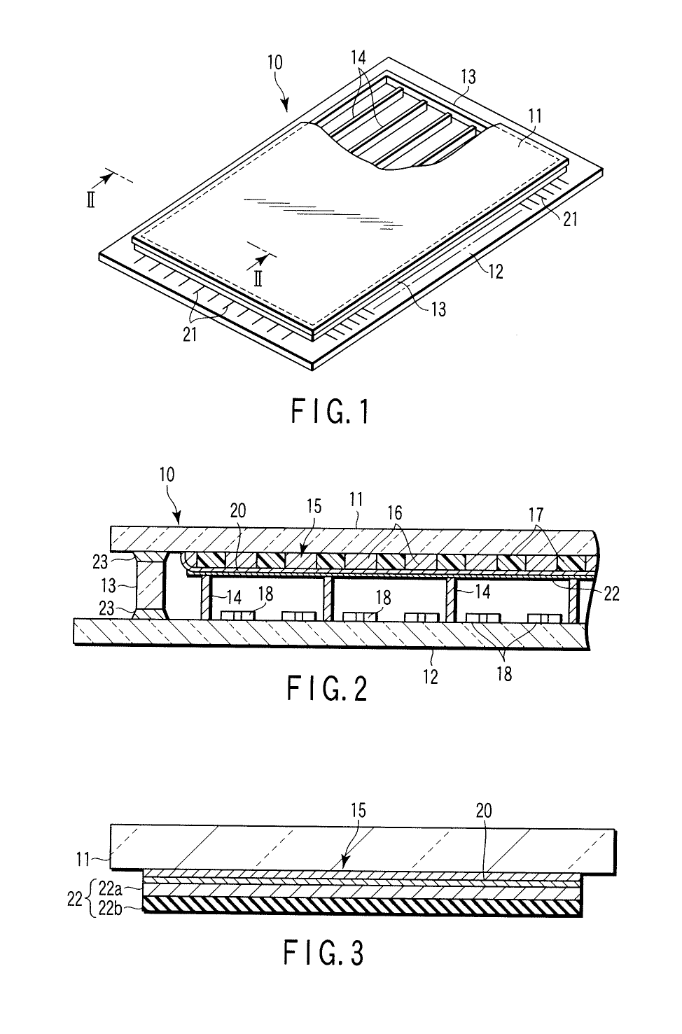

As shown in FIGS. 1 and 2, this SED includes a front substrate 11 and a rear substrate 12 each made of a rectangular glass plate as an insulating substrate, and these substrates are arranged to oppose each other with an interval of 1 to 2 mm between these substrates. The front substrate 11 and rear substrate 12 are adhered together by their peripheral portions via a side wall 13 having a rectangular frame shape, and thus a flat rectangular vacuum envelope 10, inside of which is maintained in a vacuum state, is formed. The side wall 13, which serves as a joint member, is sealed to the peripheral edge portion of the front substrate 11 and the peripheral edge portion of the rear substrate 12 each with a sealing member 23 such as a low-melting point glass or low-melting point metal, thereby joining these substrates together.

Inside the vacuum envelope 10, a plurality of spacers 14 are provided in order to support the atmospheric load applied on the front substrate 11 and rear substrate. Plate-shaped or columnar-shaped spacers can be employed as the spacers 14.

A phosphor screen 15 including red, green and blue phosphor layers 16 and a matrix-like light-shield layer 17 is formed as a display surface on an inner surface of the front substrate 11. The phosphor layers 16 may be formed in stripes or dots. A metal back 20 made of, for example, an aluminum film, is formed on the phosphor screen 15, and further a getter film 22 is formed to be overlaid on the metal back.

A number of surface conduction type electron emitting elements 18 each emitting electron beams are provided on the inner surface of the rear substrate 12, as an electron source for exciting the phosphor layers 16 of the phosphor screen 15. These electron emitting elements 18 are arranged in a plurality of columns and a plurality of rows to correspond to the pixels respectively. Each of the electron emitting elements 18 includes an electron emitting portion, which is not shown in the figures, a pair of element electrodes for applying a voltage to the electron emitting portion, etc. A number of wiring lines 21 for supplying a potential to the respective electron emitting elements 18 are provided in matrix on the inner surface of the rear substrate 12, and an end portion of each of the wiring lines is lead out to the outside of the vacuum envelope 10.

When such an SED displays an image, an anode voltage is applied to the phosphor screen 15 and metal back 20, and electron beams emitted from the electron emitting elements 18 are accelerated by the anode voltage, and then made collide on the phosphor screen. In this manner, the phosphor layers 16 of the phosphor screen 15 are excited to emit light, and thus a color image is displayed.

Next, the structure of the getter film 22 formed to be overlaid on the display surface will now be described in detail.

As shown in FIG. 3, the getter film 22 is formed of a multi-layered film including a first getter film 22a formed on the metal back 20 and a second getter layer 22b stacked on the first getter film. The first and second getter films 22a and 22b are formed of activated metals different from each other. In this embodiment, the first getter film 22a is formed of barium (B) to have a thickness of 200 nm or less, and the second getter film 22b is formed of titanium (Ti) to have a thickness of 200 nm or less.

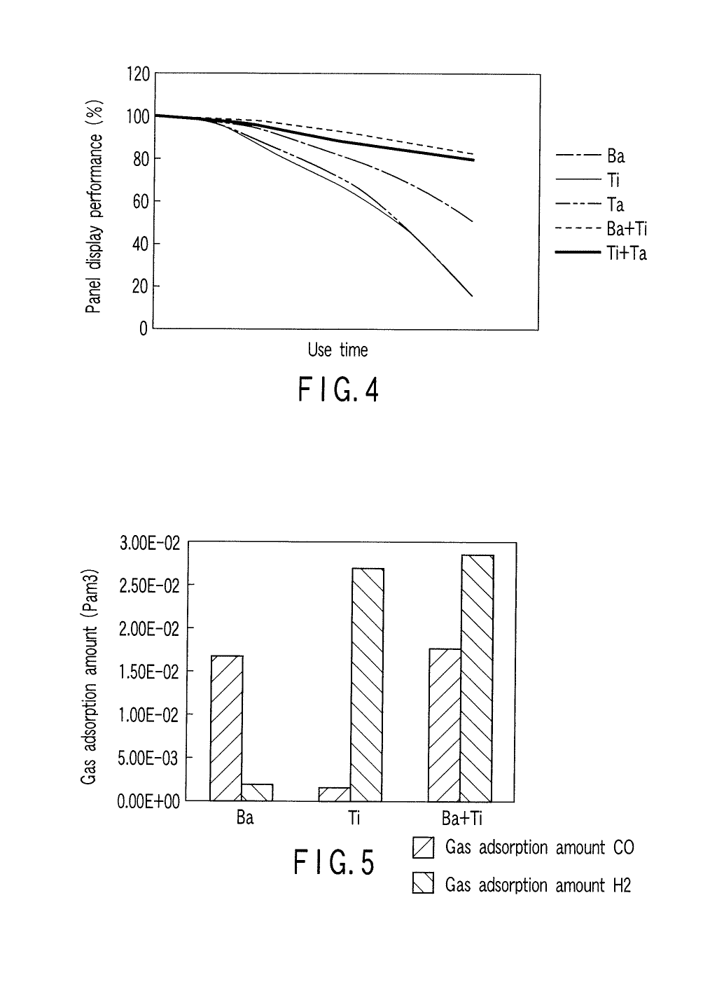

A panel comprising the getter film 22 formed to have the above-described structure and other panels were evaluated in terms of characteristics. As comparative examples, three types of SEDs, that is, one with a getter film formed of a single layer of barium, another one with a getter film formed of a single layer of titanium, and the other one with a getter film formed of multi-layers of barium and titanium, were manufactured, and then each SED was evaluated in terms of display characteristics. The results were as shown in FIG. 4.

FIG. 4 indicates a change in brightness along with the lapse of time of using the SED as the display performance retention rate with respect to the value of the brightness of the display image in the initial state of the SED being fixed to 100%. As can be seen in FIG. 4, the getter film 22 having a plurality of getter materials stacked can maintain a stable display performance over a long period of time as compared to the cases where a single layer of a getter material was used. Further, the above-described SEDs were tested in terms of the gas adsorption amount. It was confirmed as can be seen in FIG. 5 that a getter film with a high gas adsorption performance can be obtained by using a plurality of getter materials as compared to the cases where a getter film formed of a single layer of a getter material was used.

As the getter material, it is desirable that at least one of activated metals of tantalum, barium, titanium and vanadium (V), and the metals can be selected in various ways based on the characteristics innate to each metal, the vacuum atmosphere required for the image display apparatus, etc. For example, if carbonate gas causes an adverse effect on the performance of the image display apparatus, barium or tantalum may be selected. If hydrogen should desirably be eliminated, titanium should be selected. In the case where the getter film 22 is made of a multi-layered film of a plurality of types of getter materials, the characteristics of the getter material located on the outermost layer and exposed to the inner side of the envelope are enhanced. For this reason, it is desirable that the film of the getter material that can adsorb a gas to be better adsorbed should be provided on the surface side. The number of layers in the getter film may be not only two but also 3 or more, and in these cases, 2 or 3 types or more of getter materials may be used. Further, these layers may not be of the same thickness, but be different from each other. Alternatively, the getter film may be a single layer of tantalum. It should be noted that a multi-layered film is simple and advantageous in terms of production cost.

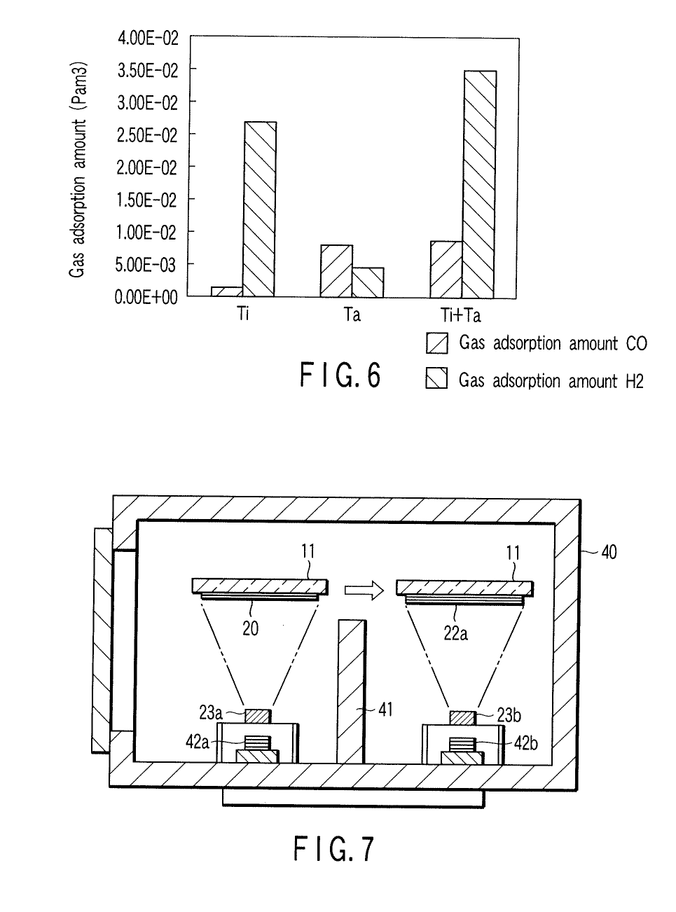

In the embodiment described above, barium and titanium were used as the getter materials, but the materials are not limited to these. Some other getter material such as tantalum may be used as well. FIG. 4 shows the display performance retaining rate of each of the SEDs of the cases where a single layer film of tantalum is used as the getter material and a multi-layered film of titanium and tantalum. FIG. 6 shows the gas absorption ability of the getter film of each of the SEDs of the same cases. As can be understood from the results shown, with use of tantalum as the getter material, a stable display performance can be maintained for a long period of time as compared to the other getter materials.

In the case where a multi-layered film of titanium and tantalum is employed as the getter film, the first getter film 22a formed on the metal back 20 is formed of titanium (Ti) to have a thickness of 20 nm, and the second getter film 22b formed to be overlaid on the first getter film 22a is formed of tantalum (Ta) to have a thickness of about 20 nm to 40 nm. The second getter film 22b is located at the outermost surface side, and exposed to the inner side of the envelope 10. Even in the case of the getter film 22 as described above, a plurality of types of getter materials are used and the characteristics of these materials are combined together to exhibit a high display performance.

For the first getter film 22a, not only titanium but also some other activated metal can be used. In the case where tantalum is used as the second getter film 22b, it is desirable that besides titanium, an activated metal having a high hydrogen adsorption ability, for example one of vanadium (V), zirconium (Zr) and barium (Ba) should be used.

Next, a method of manufacturing the above-described SED will now be described.

First, a front substrate 11 in which a phosphor screen 15 and a metal back 20 are formed on its inner surface, and a rear substrate 12 in which electron emitting elements 18 are provided, are prepared. In the meantime, in advance, a side wall 13 and a plurality of spacers 14 are joined onto the rear substrate 12. Further, for example, a sealing material is filled onto an entire circumference of the upper surface of the side wall 13 in advance. In this embodiment, indium is used as the sealing material. Subsequently, the front substrate 11, rear substrate 12 and each of the above-described structural members that form a vacuum envelope 10 are subjected to heat treatment in a baking chamber, thereby carrying out a degassing process.

Then, the front substrate 11 is unloaded from the baking chamber and as shown in FIG. 7, is loaded into a deposition chamber 40 without breaking the vacuum state. The vacuum chamber 40 is maintained at a vacuum degree of about 10⁻⁵ Pa by means of an exhaust pump, which is not shown in the figure. First and second getter materials 23a and 23b and high-frequency coils 42a and 42b that respectively heat the first and second getter materials are provided in the deposition chamber 40. Further, a partition wall 41 is set stand between the first and second getter materials 23a and 23b.

The deposition chamber 40, and the high-frequency coils 42a and 42b serving as a heating mechanism form a getter film forming device.

The front substrate 11 loaded in the deposition chamber 40 is arranged in such a state that the metal back 20 is set opposed to the first getter material 23a. Subsequently, the first getter material 23a is heated and evaporated by the high-frequency coil 42a, and thus the first getter film 22a is formed on the metal back 20. For example, titanium is used as the first getter material 23a, and is deposited by vacuum deposition carried out by induction heating using the high-frequency coil 42a.

Subsequently, the front substrate 11 is arranged at a position that opposes the second getter material 23b. With this arrangement, the second getter material 23b is heated and evaporated by the high-frequency coil 42b, and thus the second getter film 22b is formed on the first getter film 22a. For example, tantalum is used as the second getter material 23b, and is deposited by vacuum deposition carried out by induction heating using the high-frequency coil 42b. Thus, a getter film 22 which is a multi-layered film of the first getter film 22a and the second getter film 22b, is formed.

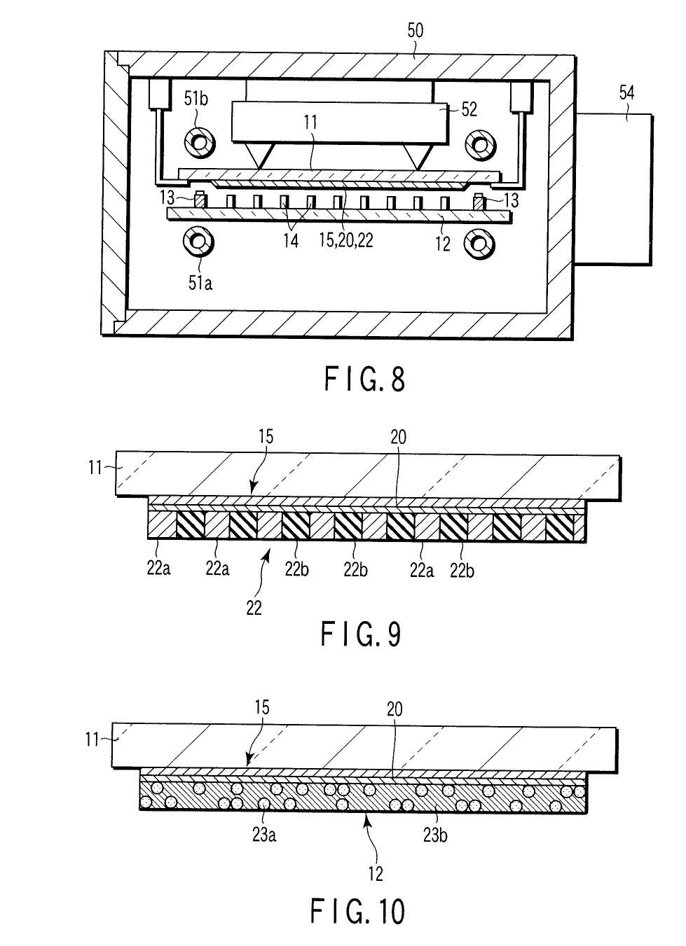

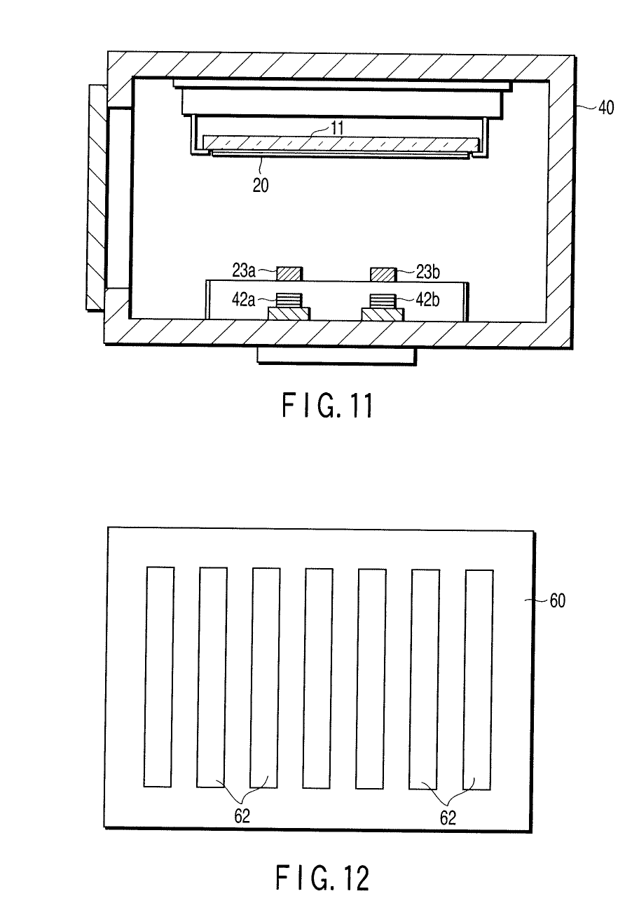

After that, the front substrate 11, on which the getter film 22 is now formed, is loaded into a sealing chamber 50 without exposing the substrate 11 to the outside air. As shown in FIG. 8, a local heating mechanism for locally heating the edge portion of the substrate and a sealing mechanism 52 for pressurizing the substrate are provided in the sealing chamber 50. The regional heating mechanism includes ring-shaped heaters 51a and 51b. The internal of the sealing chamber 50 is maintained at a high degree of vacuum in the order of 10⁻⁵ Pa by means of an exhaust pump 54. The rear substrate 12 and each of the above-described structural members that form the vacuum envelope 10 are loaded in the sealing chamber 50 without being exposed to the outside air after undergoing predetermined steps.

Subsequently, the positions of the front substrate 11 and the rear substrate 12 are adjusted such that the phosphor layer 16 and the electron emitting elements 18 formed on the respective substrates oppose each other properly. With this arrangement, only the edge portions of the rear substrate 12 and front substrate 11 are heated up to about 180° C. with the heaters 51a and 51b, and thus indium, which serves as the sealing material, is melted. While this state, the front substrate 11 is pressed towards the rear substrate 12 by the sealing mechanism 52, and thus the edge portion of the front substrate is joined to the side wall 13 via indium. After that, the members are cooled down until indium solidifies, and thus the vacuum envelope 10 is formed. With these procedures, an SED is obtained.

According to this embodiment described above, the gas adsorption ability of the getter film can be improved by forming the getter film 22 of a plurality of getter materials. Therefore, the deterioration of the electron emitting elements can be suppressed, and thus an SED that can maintain a high display performance over a long period of time can be obtained.

In connection with the structure of the getter film 22, it may be not only a multi-layered film, but also a pattern film or mixture film. According to a second embodiment shown in FIG. 9, the getter film 22 is formed as a pattern film. That is, in the getter film 22, first getter films 22a and second getter films 22b which are made of getter materials different from each other are formed to be arranged alternately one by one along with the plane direction of the front substrate 11, and they are exposed to the vacuum atmosphere. The first getter films 22a and the second getter films 22b are formed both in strips and they are extended in the longitudinal or width direction of the front substrate 11. In the case where such a pattern film is used, the ratio of the area of the getter material exposed to the vacuum atmosphere can be changed. Thus, for example, by changing the width of stripes of the first getter film 22a and second getter film 22b, the gas adsorption property of the getter film 22 can be easily controlled.

According to a third embodiment shown in FIG. 10, the getter film 22 is formed of a mixture of a plurality of types of getter materials, for example, the first getter material 23a and the second getter material 23b, which are deposited at the same time to make a mixture film. In the case where such a mixture film is used, the gas adsorption property of the getter film 22 can be easily controlled by changing the mixture ratio between the first and second getter materials.

In the second and third embodiments, three or more types of getter materials may be used in combination. As to the mixture film or pattern film, the ratio of the getter materials employed can be freely selected and therefore the adsorption performance can be easily controlled. In the second and third embodiments, the other structural members than those mentioned are the same as those of the first embodiment, and therefore the same members are designated by the same reference numerals and the detailed descriptions therefor will not be repeated.

In order to form a getter film 22 which is made of a mixture film, the front substrate 11 subjected to degassing process is loaded into a deposition chamber 40 without breaking the vacuum state as shown in FIG. 7. The vacuum chamber 40 is maintained at a vacuum degree of about 10⁻⁵ Pa by means of an exhaust pump, which is not shown in the figure. First and second getter materials 23a and 23b and high-frequency coils 42a and 42b that respectively heat the first and second getter materials are provided in the deposition chamber 40.

The front substrate 11 loaded in the deposition chamber 40 is arranged in such a state that the metal back 20 is set opposed to the first and second getter materials 23a and 23b. Subsequently, the first and second getter materials 23a and 23b are heated and evaporated by the high-frequency coils 42a and 42b at the same time, and thus the getter film 22 made of a mixture film of the first and second getter materials is formed on the metal back 20. For example, titanium and tantalum are used as the first and second getter materials 23a, and are deposited by vacuum deposition carried out by induction heating using the high-frequency coils 42a and 42b. Here, a getter film of an arbitrary mixture ratio can be prepared by controlling the deposition rate of each of the getter materials.

In order to form a getter film with a stripe structure shown in FIG. 9, a mask 60 having a cut pattern as shown in FIG. 12 is prepared. The mask 60 is formed to have a rectangular shape of substantially the same size as that of the front substrate 11, and a plurality of openings in strips are formed in parallel with each other at predetermined intervals in the mask. Subsequently, the mask 60 is loaded into the deposition chamber 40 shown in FIG. 7 and placed between the front substrate 11 and the first getter material 23a. With this arrangement, the first getter material 23a is heated and evaporated by the high-frequency coil 42a, and thus the first getter film 22a is formed in stripe on the metal back 20. For example, titanium is used as the first getter material 23a, and is deposited by vacuum deposition carried out by induction heating using the high-frequency coil 42a.

Next, the front substrate 11 is arranged at a position that opposes the second getter material 23b and the mask 60 is placed between the front substrate 11 and the second getter material 23b. With this arrangement, the second getter material 23b is heated and evaporated by the high-frequency coil 42b, and thus the second getter film 22b is formed in stripes between those of the first getter film 22a. For example, tantalum is used as the second getter material 23b, and is deposited by vacuum deposition carried out by induction heating using the high-frequency coil 42b. Thus, a getter film 22 which is the first getter films 22a and the second getter films are arranged alternatively one by one, is formed.

After that, the front substrate 11 and the rear substrate 12 are sealed by similar steps to those of the first embodiment described above, and thus a vacuum envelope 10 is obtained.

Next, the method of manufacturing an SED according to a fourth embodiment of the present invention will now be described.

First, a front substrate 11 in which a phosphor screen 15 and a metal back 20 are formed on its inner surface, and a rear substrate 12 in which electron emitting elements 18 are provided, are prepared. In the meantime, in advance, a side wall 13 and a plurality of spacers 14 are joined onto the rear substrate 12. Further, for example, a sealing material is filled onto an entire circumference of the upper surface of the side wall 13 in advance. In this embodiment, indium is used as the sealing material. Subsequently, the front substrate 11, rear substrate 12 and each of the above-described structural members that form a vacuum envelope 10 are subjected to heat treatment in a baking chamber, thereby carrying out a degassing process.

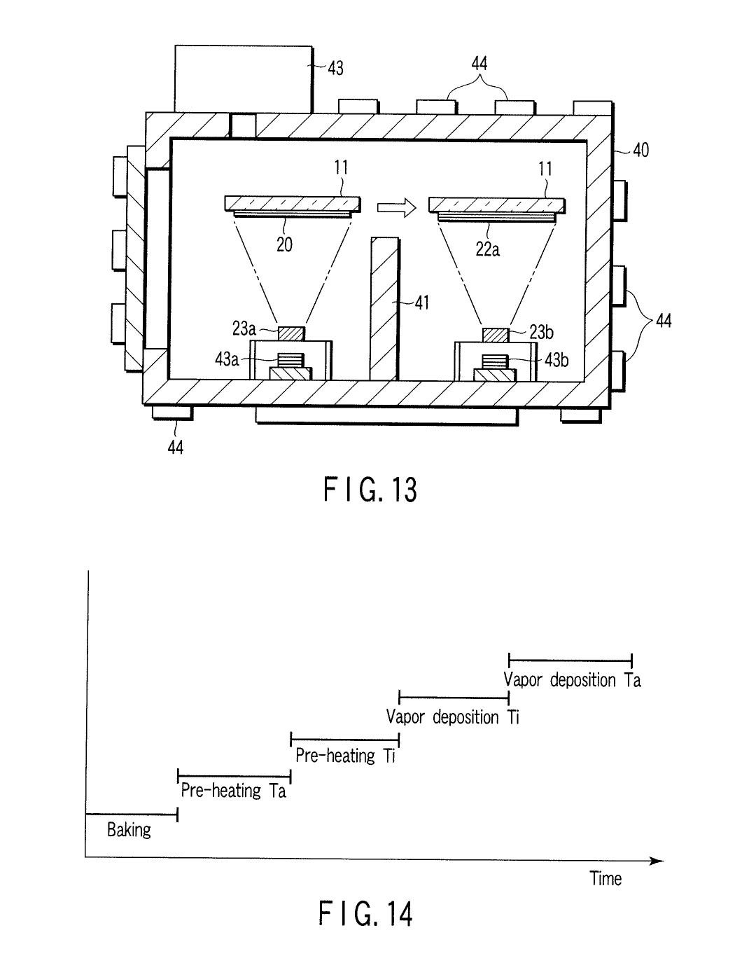

Then, the front substrate 11 is unloaded from the baking chamber and as shown in FIG. 13, is loaded into a vacuum chamber 40 without breaking the vacuum state. An exhaust pump 43 is connected to the vacuum chamber 40 so as to evacuate the vacuum chamber. First and second getter materials 23a and 23b and electron beam emission sources 43a and 43b that respectively heat the first and second getter materials are provided on the bottom portion of the vacuum chamber 40. Titanium is used as the first getter material 23a and tantalum is used as the second getter material 23b. Further, a partition wall 41 is set stand between the first and second getter materials 23a and 23b. In the vacuum chamber 40, a heater is provided to bake the vacuum chamber itself for degassing. The heater is of a sheath type made of a heating wire such as an enameled wire, or of a tape type formed of a cloth in which a ribbon-shaped heat wire is inserted, and the heater is wound around the vacuum chamber 40. A conveying mechanism that serves to support and convey the front substrate 11 is provided in the vacuum chamber 40 although it is not shown in the figure. It should be noted that the front substrate 11 is arranged in the vacuum chamber 40 in such a state that the metal back 20 faces the bottom surface side of the vacuum chamber, that is, the first or second getter material 23a or 23b.

Subsequently, as shown in FIGS. 13 and 14, the wall surface of the vacuum chamber, the conveying mechanism, etc. are heated to 120 to 150° C. by the heater, and thus the vacuum chamber itself is degassed. At the same time, the vacuum chamber is evacuated by the exhaust pump 43 so as to maintain the interior of the vacuum chamber 40 at a vacuum degree of about 10⁻⁵ Pa.

Next, electron beam is irradiated from the electron beam emission source 42b to the second getter material 23b, thereby preliminarily heating the second getter material 23b to about 3000° C. In this manner, impurities including oxide films present on the surface of the second getter material 23a are evaporated. During this operation, in order to avoid the evaporated second getter material 23b from attaching to the front substrate 11, the front substrate 11 is placed at a position that oppose the first getter material 23a. Thus, the second getter material 23b is preliminarily heated while inhibiting the adhesion of the second getter material to the front surface.

Subsequently, electron beam is irradiated from the electron beam emission source 43a to the first getter material 23a, thereby preliminarily heating the second getter material 23a to about 2000° C. In this manner, impurities including oxide films present on the surface of the first getter material 23a are evaporated. During this operation, in order to avoid the evaporated first getter material 23a from attaching to the front substrate 11, the front substrate 11 is placed at a position that oppose the second getter material 23a. Thus, the second getter material 23b is preliminarily heated while inhibiting the adhesion of the first getter material to the front surface.

Next, the front surface 11 is placed at such a position that the metal back 20 faces the first getter material 23a. After that, the first getter material 23a is heated to about 2000° C. by the electron beam emission source 43a and evaporated, and in this manner, the first getter film 22a made of titanium is deposited on the inner surface of the vacuum chamber 40 and the metal back 20.

Subsequently, the front surface 11 is placed at such a position that the metal back 20 faces the second getter material 23a. With this arrangement, the second getter material 23b is heated to about 3000° C. by the electron beam emission source 43a and evaporated, and in this manner, the second getter film 22b made of tantalum is deposited to be overlaid on first getter material 22b formed on the metal back 20. When evaporating tantalum as the second getter material, hydrogen is generated, but the generated hydrogen is absorbed into the first getter film 22a made of titanium in the vacuum chamber 40 in advance. Therefore, the second getter film 22b made of tantalum can be formed in a fresh state free of degradation, without deteriorating the vacuum degree within the vacuum chamber 40. In addition, since tantalum is a high-melting point metal, the temperature inside the vacuum chamber 40 is increased when depositing tantalum. However, the interior of the vacuum chamber is baked in advance for degassing, and therefore the deterioration of the vacuum degree in the deposition of tantalum can be prevented. In this manner, the second getter film 22b can be obtained in a fresh state without being deteriorated.

Next, the front substrate 11 on which the getter film 22 is now formed is loaded into the sealing chamber 50 shown in FIG. 8 without exposing the substrate to the outside air. Then, the front substrate 11 and rear substrate 12 are sealed together in the sealing chamber 50 by a method similar to that employed in the first embodiment described above, and thus a vacuum envelope 10 is formed. With this member, an SED is obtained.

As described above, according to the third embodiment, the gas adsorption ability of the getter film can be improved with use of the getter film 22 that is made of tantalum. Further, when the getter film 22 is formed of a plurality of getter materials including tantalum, the gas adsorption ability of the getter film can be even more improved. Thus, it is possible to obtain an SED that can maintain a high display performance over a long period of time by retaining the interior of the vacuum envelope at a high vacuum degree and thereby suppressing the deterioration of the electron beam emission elements.

In the manufacturing method according to this embodiment, the deposition of tantalum, which is the second getter material, is carried out after the first getter film is formed in the vacuum chamber in advance, and in this manner, hydrogen generated during the deposition of tantalum is adsorbed in the first getter film. Thus, the interior of the vacuum chamber 40 is maintained at a high vacuum degree, and therefore the second getter film 22b can be obtained in a fresh state without being deteriorated. Further, the interior of the vacuum chamber is baked in advance for degassing, and therefore the deterioration of the vacuum degree, which might occur during the deposition of tantalum, can be prevented. As a result, an even more fresh second getter film 22b can be obtained. Thus, it is possible to obtain an SED that can maintain a high display performance over a long period of time by fully exploiting the characteristics of tantalum as a getter and retaining the interior of the vacuum envelope at a high vacuum degree.

The present invention is not limited directly to the above-described embodiments, but the invention in its practical stages can be realized by modifying the structural elements as long as the essence of the invention does not fall out of its scope. Further, the present invention can be modified into various ways by appropriately combining some of the structural elements disclosed in the above-described embodiments. For example, it is possible to delete some of the structural elements from all the structural elements indicated in the embodiments. Further, the structural elements from different embodiments may be combined together appropriately to make another invention.

For example, in the above-described method of manufacturing an image display apparatus, the inside of the vacuum chamber is baked in advance, and then the getter film is deposited, but the baking step may be omitted. Even without the baking step, when the first getter film is formed in the vacuum chamber, and then the second getter film, which is made of tantalum, is formed on the substrate, the deterioration of the vacuum degree can be suppressed and a fresh getter film can be formed.

Further, in the above-described embodiment, the first getter film is formed in the vacuum chamber and on the metal back formed on the front substrate. However, it is alternatively possible to form the first getter film only in the vacuum chamber. In this case, the first getter material 23a is evaporated while the front substrate 11 is placed to a position that faces toe the second getter material 23b. After that, the second getter material 23b is evaporated and thus the second getter film 22b is formed on the metal back of the front substrate 11. Thus, the getter film of the front substrate 11 is formed of a single layer of tantalum. Even with this structure, hydrogen is adsorbed into the first getter film formed in the vacuum chamber during the deposition of the second getter film, and thus the second getter film can be formed in a fresh state without being deteriorated on the metal back. Thus, the characteristics of tantalum as a getter can be fully exploited. Accordingly, the interior of the vacuum envelope can be maintained at a high vacuum degree. Therefore, it is possible to obtain an SED that can maintain a high display performance over a long period of time.

The measurements, materials, etc. of each structural element are not limited to the values and materials specified in the above-described embodiments, but they can be selected in various ways in accordance with necessity. The getter material is not limited to barium, titanium or the like, some other metal materials, organic materials, inorganic materials, etc. can be selected. The getter film may be deposited not only on the front substrate but also on other structural members located within the vacuum envelope. The deposition method is not limited to the deposition by high-frequency heating or electron beam, but also it is alternatively possible to select deposition by heating of electrical energization.

Further, the present invention may be applied not only to an SED but also an image display apparatus of other types such as FED and PDP.

What is claimed is:

1. An image display apparatus comprising:
an envelope including a front substrate on which a display surface is provided, and a rear substrate arranged to face the front substrate,
the front substrate including a metal back formed to be overlaid on the display surface and a getter film formed of two types or more of activated metals, formed on the metal back.

2. The image display apparatus according to claim 1, wherein the getter film is formed on an entire region of a display region of the front substrate.

3. The image display apparatus according to claim 1, wherein at least one type of the activated metals that form the getter film is selected from the group consisting of tantalum, barium and titanium and vanadium.

4. The image display apparatus according claim 1, wherein the getter film is formed of thin films of two types or more of activated metals stacking one on another.

5. The image display apparatus according to claim 4, wherein the getter film includes a first getter film made of an activated metal on the metal back, and a second getter film made of tantalum to be overlaid on the first getter film.

6. The image display apparatus according to claim 5, wherein the first getter film contains one selected from the group consisting of tantalum, barium and titanium and vanadium.

7. The image display apparatus according to claim 1, wherein the getter film is formed of a mixture of two types or more of activated metals.

8. The image display apparatus according to claim 1, wherein the getter film is formed to expose two types or more of activated metals to an outermost surface.

9. An image display apparatus comprising:
an envelope including a front substrate on which a display surface is provided, and a rear substrate arranged to face the front substrate,
the front substrate including a metal back formed to be overlaid on the display surface and a getter film made of tantalum, formed on the metal back.

10. A method of manufacturing an image display apparatus comprising: an envelope including a front substrate on which a display surface is provided, and a rear substrate arranged to face the front substrate, the front substrate including a metal back formed to be overlaid on the display surface and a getter film made of two types or more of activated metals, formed on the metal back, the method comprising:
forming the getter film of two types or more of activated metals, to be overlaid on the metal back; and
sealing the rear substrate and the front substrate on which the getter film is formed, to each other by peripheral edge portions thereof, thereby forming the envelope.

11. The manufacturing method according to claim 10, wherein the forming of the getter film and the sealing of the rear substrate and the front substrate are carried out in a vacuum atmosphere.

12. The manufacturing method according to claim 10, wherein a first getter material is deposited on the metal back to form a first getter film in a vacuum atmosphere and then a second getter material of a different type from that of the first getter material, is deposited to form a second getter film be overlaid on the first getter film in a vacuum atmosphere.

13. The manufacturing method according to claim 10, wherein a first getter material and a second getter material of a different type from that of the first getter material, are deposited at the same time on the metal back in a vacuum atmosphere to form a mixture layer containing the first and second getter materials.

14. A method of manufacturing an image display apparatus comprising: an envelope including a front substrate on which a display surface is provided, and a rear substrate arranged to face the front substrate, the front substrate including a metal back formed to be overlaid on the display surface and a getter film formed on the metal back, the method comprising:
placing the front substrate on which the metal back is formed, in a vacuum chamber;
after evacuating the vacuum chamber to vacuum, evaporating a first getter material made of an activated metal in the vacuum chamber to form a first getter film in the vacuum chamber;
forming a second getter film on the metal back by evaporating a second getter material made of tantalum in the vacuum chamber after forming the first getter film; and
sealing the front substrate on which the second getter film is formed and the rear substrate to each other by peripheral edge portions thereof to form the envelope.

15. The manufacturing method according to claim 14, wherein upon forming the first getter film in the vacuum chamber, the first getter film is formed on an inner surface of the vacuum chamber and on the metal back, and the second getter film is formed on the metal back to be overlaid on the first getter film.

16. The manufacturing method according to claim 14, wherein at least one selected from the group consisting of and titanium, barium, vanadium and zirconium is used as the first getter material.

17. The manufacturing method according to claim 14, wherein the first getter film is formed after the vacuum chamber is backed for degassing.

18. The manufacturing method according to claim 17, wherein the second getter material and first getter material are preliminarily heated in this order in a state where adhesion of the getter material to the front surface is inhibited after the baking; and the first getter film and second getter film is formed in the order after the preliminary heating.

19. The manufacturing method according to claims 14 to 16, wherein the front substrate and rear substrate are sealed to each other in the vacuum atmosphere after forming the second getter film.
